(19) United States
(12) Patent Application Publication
(10) Pub. No.: US 2026/0350462 A1
(43) Pub. Date: Nov. 5, 2026

(54) CONTEXT-AWARE SELECTION OF DIGITAL CONTENT ITEMS

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Bangalore (IN)

(73) Assignee: Motorola Mobility LLC, Chicago, IL (US)

(21) Appl. No.: 19/195,681

(22) Filed: Apr. 30, 2025

(51) Int. Cl. G06N 20/00

(52) U.S. Cl. CPC G06N 20/00

(57) ABSTRACT

In aspects of context-aware selection of digital content items, a mobile device extracts event data identifying an event to be attended by a user of the mobile device. The mobile device determines, using a machine learning (ML) model and based on the event data, event context data associated with the event. The mobile device selects, using the ML model, a digital content item from a set of digital content items stored in an item database based on the event context data and item context data associated with the digital content item. The mobile device generates a user interface indicating the selected digital content item. In some examples, the mobile device scans content of digital applications on the mobile device and identifies indicators of the event and/or indicators of digital content items within the scanned content.

### BACKGROUND

Mobile devices, such as tablet devices, smartphones, and the like, are capable of performing a multitude of tasks in a wide range of environments. These devices have evolved to offer various functionalities beyond traditional communication, such as managing personal information and scheduling events. Additionally, mobile devices often include high-quality cameras for capturing memories, documenting information, or interacting with digital services. As many users rely on mobile devices to manage their daily lives, there is growing interest in leveraging the capabilities of these devices to provide more personalized and context-aware experiences. However, the integration of various data sources and the ability to provide relevant and timely services remain areas of ongoing development.

### BRIEF DESCRIPTION OF THE DRAWINGS

Implementations of the techniques for context-aware selection of digital content items are described with reference to the following Figures. The same numbers may be used throughout to reference like features and components shown in the Figures.

FIG. 1 illustrates an example communication system for context-aware selection of digital content items in accordance with one or more implementations as described herein.

FIG. 2 further illustrates an example of context-aware selection of digital content items in accordance with one or more implementations as described herein.

FIG. 3 illustrates an example of a graphical user interface (GUI) for context-aware selection of digital content items in accordance with one or more implementations as described herein.

FIGS. 4-6 illustrate example methods for context-aware selection of digital content items in accordance with one or more implementations of the techniques described herein.

FIG. 7 illustrates various components of an example device that may be used to implement the techniques for context-aware selection of digital content items as described herein.

### DETAILED DESCRIPTION

Implementations of the techniques for context-aware selection of digital content items may be implemented as described herein. A mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for context-aware selection of digital content items as described herein. For example, a mobile device implements a context-aware selection module that analyzes event data, item information, and contextual factors to select contextually-appropriate digital content items. In variations, the context-aware selection module receives user input via a user interface of the mobile device that triggers or initiates the selection process for an upcoming event. The mobile device analyzes available data and generates selection notifications in real-time or near real-time. In one or more implementations, a server device includes a context-aware selection manager, which can be used to implement aspects of the techniques described herein. In implementations, the context-aware selection module and/or the context-aware selection manager can implement or be implemented by a machine learning (ML) model or algorithm (e.g., a neural network, AI algorithms).

Current technical approaches to managing digital content on mobile devices suffer from significant computational and architectural limitations, and often fail to appropriately or efficiently utilize ML capabilities. For example, in the domain of content selection and recommendation systems, existing technical solutions implement rudimentary classification algorithms without the capability to perform multi-dimensional context analysis. Such systems employ simplistic data models that lack complex pattern recognition capabilities, such as basic keyword matching or rule-based filtering mechanisms. As a result, conventional techniques are incapable of effectively correlating metadata with appropriate contexts, providing suboptimal utilization of computational resources and generating less relevant recommendations.

Further, current technical implementations operate with fragmented data architectures, creating inefficient data processing pipelines that fail to integrate information from diverse sources such as calendar databases, messaging applications, media storage systems, and social networking platforms. Moreover, existing approaches store minimal metadata about digital assets, limiting the parameters available for contextual matching algorithms. This architectural fragmentation creates significant computational overhead when attempting to establish relational connections between digital content metadata and contextual parameters. The absence of unified data processing frameworks and efficient ML models for contextual analysis forces systems to rely on resource-intensive manual search operations across disparate databases, resulting in high latency and processing inefficiencies, particularly when operating under time-constrained scenarios or when processing large volumes of digital content. Thus, a technical challenge lies in developing systems that can efficiently process and correlate large volumes of heterogeneous data in real-time, while implementing adaptive learning mechanisms that continuously refine selection algorithms based on usage patterns and feedback signals.

The present disclosure addresses these technical limitations through an integrated architecture that leverages ML models to process and store contextual data and generate relevant selections from distributed content repositories. Aspects of the described techniques implement always-on sensing capabilities that enable a mobile device to continuously gather and analyze contextual information about a user's environment and activities. The mobile device may collect data from various sources, including the device itself, connected services, other user devices, and relevant individuals (e.g., via social media accounts, connected devices, and the like). By leveraging ML algorithms to process this diverse array of data, the mobile device can develop a comprehensive understanding of the user's context at any given moment. Additionally, the mobile device may store the collected contextual data in a local database, allowing it to refer back to historical information, learn from past patterns, and analyze trends over time. This context-aware system enables a mobile device to predict future events and scenarios, allowing it to proactively assist a user in various ways. For example, the mobile device may analyze weather forecasts in conjunction with the user's calendar and travel patterns to anticipate potential delays. In response, the mobile device may automatically adjust the user's morning alarm to an earlier time, ensuring they have sufficient time to prepare and commute despite adverse weather conditions. ongoing

As described herein, such predictive capabilities can be implemented in numerous scenarios, such as suggesting appropriate attire or other items based on anticipated events and social interactions. For example, the mobile device can utilize always-on sensing and data collection to maintain (e.g., manage, generate, update) an item database that includes digital representations of items—referred to herein as digital content items—owned by the user, such as apparel items, personal items, decor, and the like. The item database includes information about the items, such as item types, attributes (e.g., characteristics, traits), origins (e.g., from where it was purchased, from whom it was received), significance, and so forth. The mobile device may continuously scan applications on the mobile device to detect items and collect related data to store in the item database.

The mobile device implements an item selection module that detects upcoming user events and analyzes information (e.g., item database information, detected event data, and/or other digital content) to provide contextually relevant item selections. Upon detection of an upcoming event, the item selection module extracts event data from various device applications such as calendars, messaging systems, and social media platforms. The item selection module can refer to the item database to identify an appropriate digital content item for recommendation to the user. For example, using an ML model, the item selection module can analyze the event data to determine a corresponding context (e.g., occasion, formality type, significance, etc.). Based on the context, the ML model determines one or more item attributes relevant to or otherwise appropriate for the event and searches through the item database for digital content items having the one or more item attributes. In some examples, the ML model can determine item attributes to avoid. For example, for an afternoon lunch with a client, the ML model can search for business casual apparel items and accessories and may discard apparel items having a logo associated with the client's competitor. The ML model determines a respective relevance level for each of the digital content items, according to which the ML model selects a digital content item. The selected digital content item(s) can be presented to the user through a generated user interface, providing timely and personalized recommendations for upcoming events or activities.

The techniques described herein support improved efficiency and accuracy in digital content management and context-aware selection processes. By collecting, analyzing, and integrating data from multiple sources, the item selection module provides a holistic digital view of a user's assets in relation to their events and activities. Further, the described techniques utilize ML models capable of analyzing complex contextual information and determining intuitive mappings between items and events, providing increased computational efficiency and improved relevance in generated recommendations. This context-aware, unified data processing framework enables seamless correlation between digital content metadata and event context parameters, eliminating the resource-intensive manual search operations across disparate databases that plague conventional systems. Additionally, by learning from user behavior and feedback, the ML models allow for increasingly accurate and personalized recommendations over time, enhancing overall utility and relevance of a user's collection compared to traditional, siloed content management systems.

While features and concepts of the described techniques for context-aware selection of digital content items is implemented in any number of different devices, systems, environments, and/or configurations, implementations of the techniques for context-aware selection of digital content items are described in the context of the following example devices, systems, and methods.

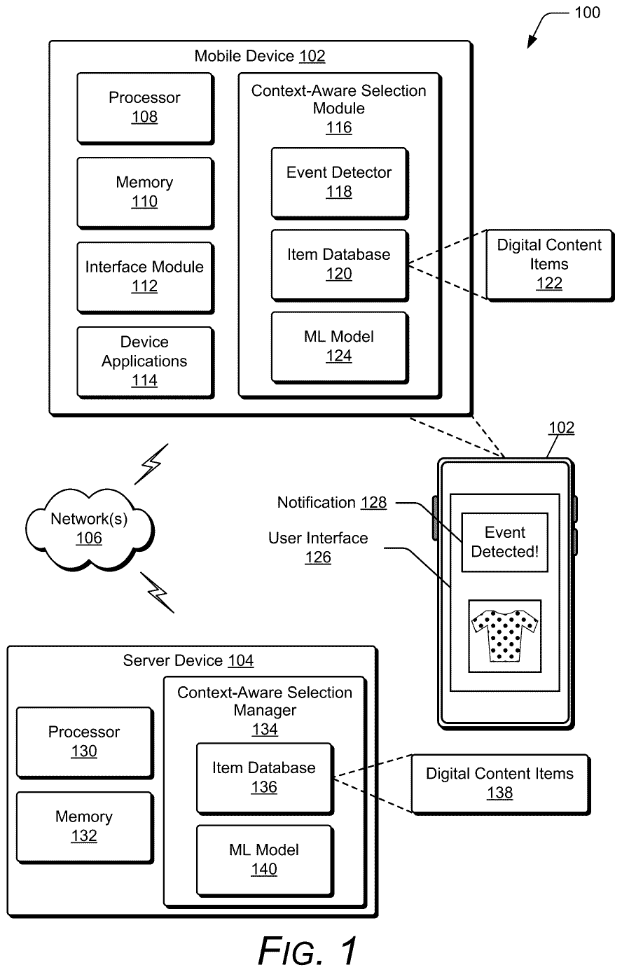

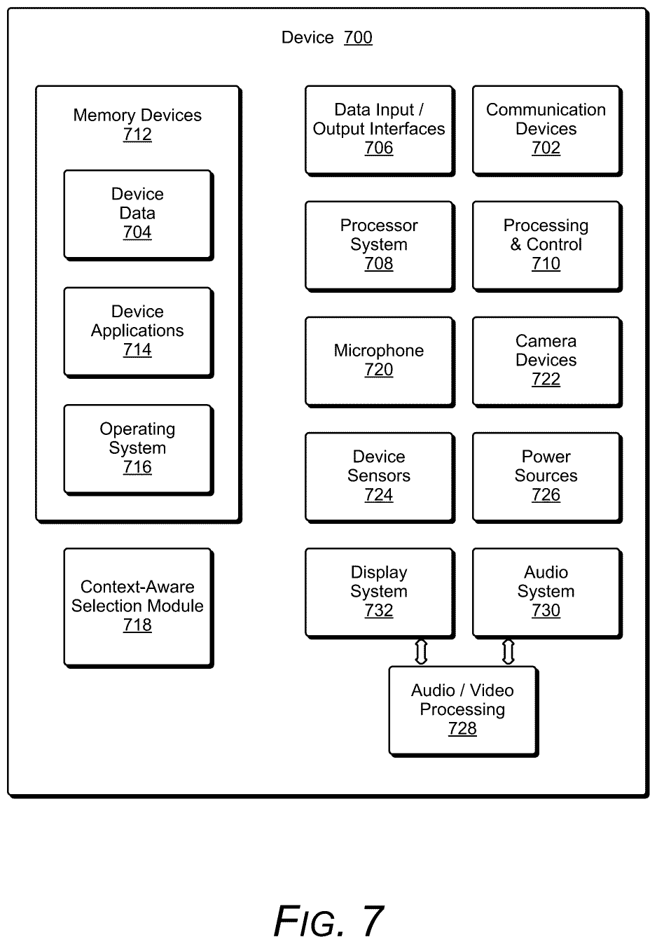

FIG. 1 illustrates an example communication system 100 for context-aware selection of digital content items as described herein. The communication system 100 includes a mobile device 102, a server device 104, and a network 106. Examples of the mobile device 102 include any type of wireless device, mobile device, smartphone, tablet, computing device, communication device, or other type of portable electronic device. The mobile device 102 can be implemented with various components, such as a processor system and memory, as well as any number and combination of different components as further described with reference to the example device shown in FIG. 7. In implementations, the mobile device 102 includes various capabilities for wireless communication with other devices. For example, the mobile device 102 can include WiFi, cellular, Bluetooth, Ultra Wideband (UWB), near field communication (NFC), or other wireless communication interfaces. Similarly, the server device 104 can be implemented with various components, such as a processor system and memory, as well as any number and combination of different components as further described with reference to the example device shown in FIG. 7.

In some implementations, the devices, applications, modules, and services described herein communicate via the network 106, such as for data communication between the mobile device 102 and the server device 104. The network 106 can include wired and/or wireless networks implemented using any type of network topology and/or communication protocol. The network 106 may represent or include a combination of two or more networks, including IP-based networks, cellular networks, and/or the Internet. The network 106 can also include mobile operator networks managed by mobile network operators and/or other network operators, such as communication service providers, mobile phone providers, and/or Internet service providers.

The mobile device 102 includes various functionality that enables the device to implement different aspects of context-aware selection of digital content items, as described herein. The mobile device 102 includes components, including a processor 108, a memory 110, and an interface module 112. The processor 108 and memory 110 provide data processing capabilities and data storage for the mobile device 102. In one or more examples, the interface module 112 represents functionality enabling the mobile device 102 to interconnect and interface with other devices and/or networks, such as the server device 104 via the network 106. For example, the interface module 112 enables wireless connectivity between the mobile device 102 and the server device 104 through cellular networks, Wi-Fi, Bluetooth, or other communication protocols. This connectivity allows the mobile device 102 to transmit event data to the server device 104 and receive digital content item selections in return. The mobile device 102 can include and implement various device applications 114, such as calendar applications, messaging applications, web browser applications, email applications, photo/video applications, and/or social media applications, among other examples.

In the example communication system 100, the mobile device 102 implements a context-aware selection module 116 (e.g., as a device application). The context-aware selection module 116 includes an event detector 118, an item database 120 storing digital content items 122, and an ML model 124 for analyzing data and generating recommendations. As shown in this example, the context-aware selection module 116 represents functionality (e.g., logic, software, and/or hardware) enabling aspects of the described techniques for context-aware selection of digital content items. The context-aware selection module 116 can be implemented as computer instructions stored on computer-readable storage media and can be executed by a processor system of the mobile device 102. Alternatively, or in addition, the context-aware selection module 116 can be implemented at least partially in hardware of the device.

In one or more implementations, the context-aware selection module 116 includes independent processing, memory, and/or logic components functioning as a computing and/or electronic device integrated with the mobile device 102. Alternatively, or in addition, the context-aware selection module 116 can be implemented in software, in hardware, or as a combination of software and hardware components. In this example, the context-aware selection module 116 is implemented as a software application or module, such as executable software instructions (e.g., computer-executable instructions) that are executable with a processor system of the mobile device 102 to implement the techniques and features described herein. As a software application or module, the context-aware selection module 116 can be stored on computer-readable storage memory (e.g., memory of a device), or in any other suitable memory device or electronic data storage implemented with the controller. Alternatively or in addition, the context-aware selection module 116 is implemented in firmware and/or at least partially in computer hardware. For example, at least part of the context-aware selection module 116 is executable by a computer processor, and/or at least part of the content manager is implemented in logic circuitry.

The mobile device 102 further includes a user interface 126 for display to a user, such as on a display screen of the mobile device 102. For example, the context-aware selection module 116 can generate notifications 128 to be displayed via the user interface 126 to indicate selected digital content items to the user. In some examples, the user interface 126 includes or is an example of a graphical user interface (GUI) associated with the context-aware selection module 116 and/or one or more device applications 114 to facilitate user interactions with digital content. A user may input information via interactable elements of the GUI (e.g., fill in a text element, elect a selectable element, or the like). For example, the user interface 126 may include controls for capturing photos, creating calendar events, or composing messages. As another example, the user interface 126 may display prompts requesting user input, such as user input indicating an upcoming event or one or more digital content items 122.

The server device 104 includes various functionality that enables it to implement different aspects of context-aware selection of digital content items, as described herein. The server device 104 contains components such as a processor 130, memory 132, and a context-aware selection manager 134. The context-aware selection manager 134 includes an item database 136 storing digital content items 138. The context-aware selection manager 134 implements or is implemented by an ML model 140. The server device 104 can communicate with the mobile device 102 to receive event data, analyze contextual information, select appropriate digital content items, and provide indications of a selected digital content item back to the mobile device 102 for display to the user via the user interface 126.

In one or more implementations, the context-aware selection module 116 implements or is implemented by the ML model 124. The ML model 124 may include or be an example of a neural network, artificial intelligence (AI) algorithms, a convolutional neural network (CNN), and/or any other type of ML model. As used herein, the term “ML model” refers to a computer representation that is trainable based on inputs to approximate unknown functions. For example, an ML model can utilize algorithms to learn from, and make predictions on, inputs of known data (e.g., training and/or reference images) by analyzing the known data to learn to generate outputs. The ML model 124 may be trained on diverse datasets including various types of event data, user preferences, and digital content attributes. For instance, the ML model 124 may learn to associate clothing items with specific event types or recognize patterns in a user's past choices. The training process may involve supervised learning, where the ML model 124 is presented with labeled examples of events and corresponding appropriate digital content items. As the ML model 124 processes more data over time, it can adapt to individual user preferences and improve the accuracy of its recommendations.

In one or more implementations, and similar to the context-aware selection module 116, the context-aware selection manager 134 can implement or be implemented by an ML model 140 that can analyze event information and select a digital content item from an item database 136. The context-aware selection manager 134 implemented as the ML model 140 may include AI, an ML model or algorithm, a CNN, and/or any other type of ML model.

The mobile device 102 and the server device 104 can process and analyze various types of digital content. As used herein, the term “digital content” refers to information or media that is created (e.g., generated), processed, stored, transmitted, or displayed in a digital format, such as by one or more device applications 114. Examples of digital content may include, but are not limited to, photos, videos, text messages, calendar entries, social media posts, documents, and audio recordings. Additionally, digital content can correspond to (e.g., indicate, denote, represent) real-world items. As used herein, the term “digital content item” refers to an individual element of digital content that represents a real-world item owned by a user, such as a digital representation of an apparel item, an accessory, a decorative item, or other physical possession catalogued in a digital format. For example, the item database 120 and the item database 136 serve as comprehensive repositories for storing and organizing digital content items 122 and digital content items 138, respectively, associated with a user of the mobile device 102. These databases are designed to maintain a structured catalogue (e.g., index, directory, log) of digital representations of real-world items owned by the user, such as apparel, accessories, decorative items, and other personal possessions.

While the examples described below generally relate to the context-aware selection module 116, ML model 124, item database 120, and digital content items 122 at the mobile device 102, these examples and techniques may also be applicable to and implemented by the context-aware selection manager 134, ML model 140, item database 136, and digital content items 138 at the server device 104. That is, the techniques described herein may be implemented either locally at the mobile device 102 or implemented at the server device 104 based on communications with the mobile device 102. For example, the event detector 118 may transmit, to the server device 104, an indication of an event detected at the mobile device 102. The server device 104 may implement the ML model 140 to select a digital content item 138 from the item database 136 according to the described techniques. The server device 104 may transmit, to the mobile device 102, an indication of the selected digital content item 138 for display via the user interface 126. This distributed approach allows for flexibility in processing and storage, enabling the communication system 100 to leverage the computational resources of both the mobile device 102 and the server device 104.

The mobile device 102 may implement always-on sensing capabilities to continuously gather and analyze contextual information about a user's environment and activities. The mobile device 102 may collect data from various sources, including the device itself (e.g., model, color, location, orientation, surroundings, connectivity), connected services (e.g., time-critical events, future appointments, notifications, current location, user attention), other devices (e.g., connected devices, zone proximity, wireless signals, user interaction), and information related to friends and family (e.g., their devices, locations, and statuses). The mobile device 102 may implement the context-aware selection module 116 and the ML model 124 to process the collected data to infer the user's context in real-time, e.g., by generating contextual information using the ML model 124. The mobile device 102 can store the collected data and/or generated contextual data in the item database 120. Additionally, the mobile device 102 can utilize the item database 120 to refer back to historical information, learn from past patterns, and analyze trends over time to improve the accuracy and relevance of its recommendations.

For example, the mobile device 102 implements the item database 120 to maintain data about digital content items 122 associated with the user. The item database 120 may represent one or more storage systems and/or storage devices capable of storing digital content items and associated metadata. Each entry in the item database 120 corresponds to a respective digital content item 122 and may include metadata such as item type, attributes, origin information, and usage history. Usage history may refer to information related to the user's interactions with digital content items 122 and/or their corresponding physical items, such as a quantity of instances in which the user wore an apparel item or displayed a piece of decor.

In implementations, the item database 120 is manually compiled, such as by direct user input via the user interface 126. For example, the context-aware selection module 116 at the mobile device 102 may generate the user interface 126 to enable the user to input information about an item, such as photos and/or videos, an item type, attributes, origin information, significance or sentimental value, associated occasion/event information (e.g., an associated holiday, an event in which a gift was received, a sports event associated with a team jersey, etc.), associated individuals (such as a person from whom an item was received as a gift), and usage history. Using the user input, the context-aware selection module 116 generates and stores a respective database entry for each item, where the respective database entry corresponds to a digital content item 122 representing the item. The context-aware selection module 116 populates each database entry with corresponding information (e.g., metadata, context data) about the digital content item 122.

Additionally, or alternatively, the item database 120 may be automatically generated by the context-aware selection module 116, e.g., without user input. In such examples, the context-aware selection module 116 scans (e.g., systematically examines, parses, crawls) digital content on the mobile device 102 to identify indicators of items. The context-aware selection module 116 may also integrate with other device applications 114 to identify digital content items 122 and gather associated data. For example, the context-aware selection module 116 may implement the ML model 124 to parse text-based content such as messages, emails, and social media posts to identify indicators (e.g., key words or phrases) of items, such as references to purchases, gifts received, or items of significance to the user. The ML model 124 can also utilize computer vision algorithms (e.g., image recognition, object detection) to detect and classify indicators in the form of objects in photos and videos, such as clothing items, accessories, or decorative pieces, as well as optical character recognition (OCR) to extract text information like brand names or product descriptions.

Based on the indicators, the ML model 124 may identify a digital content item 122 and associated item data. As described herein, item data refers to information that directly describes an item, such as an item type, attribute (e.g., color, style, size, etc.), dimension(s), source information (e.g., when and where an item was acquired or used), and so forth. The ML model 124 may be trained (e.g., pre-trained) to associate the indicators with digital content items 122 and to extract relevant item data, based on which the context-aware selection module 116 generates, populates, and stores database entries. For instance, the ML model 124 may extract, from a user-captured photo of an item, metadata such as the date, time, location, and any tags or descriptions associated with the image, and may store the metadata in a database entry of the item database 120 corresponding to a digital content item 122 representing the item.

Additionally, the context-aware selection module 116 implements the ML model 124 to determine or otherwise generate context data (e.g., item context data) associated with each digital content item 122 and may store the context data in the item database 120. As described herein, item context data refers to information providing context about an item's significance, usage, and relationships. For example, item context data can include, but is not limited to, usage information (e.g., instances, frequency, time/date, and/or recency of use), associated events (e.g., occasions, activities), relationships to other items or individuals, emotional significance or sentimental value, formality level, seasonal relevance, social contexts, user preferences, associated individuals or groups, and the like. While item data provides factual information about the digital content item itself, item context data offers insights into how, when, and why an item is significant or useful to the user.

For example, the context-aware selection module 116 implements the ML model 124 to infer or otherwise derive item context data for a digital content item 122 by analyzing patterns, user behavior, and relationships between the digital content item 122 and other information (e.g., extracted information). The ML model 124 may apply natural language processing to understand item contexts, and can infer or otherwise determine usage patterns indicative of how the user interacts with an item. In some examples, the ML model 124 analyzes extracted information to estimate a significance or sentimental value (e.g., according to a scale, from high significance to low significance) associated with an item. As a non-limiting example, the context-aware selection module 116 may implement the ML model 124 to extract and analyze information from social media posts, photo captions, and user-added tags to infer an item's sentimental value to the user, associated events or individuals, relationships with other items, and so forth. The ML model 124 can analyze calendar entries for events associated with specific items (such as formal wear for a wedding). Additionally, the ML model 124 can utilize metadata associated with digital content, such as timestamps, geolocation data, and user-added tags, to infer information about when and where items were acquired or used. Geolocation metadata from images or social media posts provides insights into where an item was purchased or worn, indicating the item's suitability for different locations or climates.

As the ML model 124 scans and analyzes digital content, it may populate the item database 120 with entries for each identified digital content item 122, including extracted and inferred information (e.g., item data, item context data) such as item types, attributes, origins, relationships, and usage patterns, among other examples. The ML model 124 correlates metadata from multiple sources to build a comprehensive understanding of an item's context. For instance, the ML model 124 may combine timestamp data from photos with calendar entries from the same date to associate items with specific events or occasions. The ML model 124 can refine and categorize this information, improving the accuracy and relevance of the data stored in the item database 120 over time.

In the example communication system 100, the context-aware selection module 116 implements the event detector 118 to identify an upcoming event. In implementations, the event detector 118 implements or is implemented by the ML model 124 to perform the techniques described herein. When an event is detected, the context-aware selection module 116 initiates a selection process to select, from the item database 120, at least one digital content item 122 to recommend to the user for the event. The context-aware selection module 116 may implement the ML model 124 to analyze event context data and item context data to identify relevant digital content items 122, from among which the at least one digital content item 122 is selected. The selected digital content item(s) 122 may correspond to apparel items appropriate to wear to the event, a gift received from an attendee of the event that the user may display during the event, or the like. The context-aware selection module 116 generates the notification 128 to indicate the selected digital content item(s) 122 to the user via the user interface 126.

An “event” as defined herein may be a planned or scheduled occurrence, activity, occasion, etc. that the user of the mobile device 102 intends to attend or participate in. Examples of events may include, but are not limited to, a social gathering, professional meeting, personal appointment, entertainment activity, or any other type of engagement. Events may be associated with attributes and context such as a time, date, duration, location, type of event, its purpose, attendees, dress code (e.g., formality level), and any associated activities or requirements. To detect an event, the event detector 118 may continuously monitor digital content of the mobile device 102 for event indicators (e.g., key words, phrases, images, or the like that refer to or otherwise indicate an event). For example, the event detector may scan digital content associated with the device applications 114 to identify event indicators, such as calendar entries, event invitations sent and received via messages or email, or location check-ins on social media.

Upon detection of an event, the context-aware selection module 116 extracts event data based on the indicator(s). For example, the event detector 118 may detect an event from an entry in a calendar application. Based on (e.g., subsequent to) the detecting, the context-aware selection module 116 may extract event data from the entry, such as a date, time, location, type of event (e.g., social gathering, professional meeting, personal appointment), and attendee(s). The context-aware selection module 116 implements the ML model 124 to parse and interpret the extracted event data and determine or otherwise generate event context data associated with the event, e.g., in a similar manner to determining item context data. For instance, the ML model 124 might recognize key words or phrases that indicate the formality level of the event, its purpose, or any particular requirements (e.g., dress code, admissions, etc.). Additionally, or alternatively, the ML model 124 may predict event context data based on historical information or trends. In implementations, the ML model 124 scans additional relevant digital content to determine the event context data, such as contact information or social media accounts associated with one or more attendees, historical event data associated with the user, and the like. For example, for a client meeting, the ML model 124 may identify information associated with the client's company or business.

The ML model 124 leverages its understanding of the event context to identify one or more item attributes that are relevant and appropriate for the event. The ML model 124 may analyze aspects of the event context, such as the formality level, location, time, attendees, and purpose, to determine which characteristics of digital content items 122 are suitable. For example, if the event context data indicates a formal evening wedding, the ML model 124 might generate item attributes such as “formal wear,” “evening appropriate,” “dark colors,” or “suit and tie” for male attendees. For a casual outdoor picnic, it might determine attributes like “casual,” “comfortable,” “weather-appropriate,” or “outdoor-friendly.” As another example, if the event involves meeting with a particular client or colleague, the ML model 124 might prioritize attributes related to items previously worn during successful interactions with that person. Similarly, for recurring events, the ML model 124 may generate or select attributes that ensure variety in recommendations, avoiding repetition of recently used items. In implementations, the ML model 124 can additionally or alternatively generate attributes to avoid for the event. In the example of a client meeting, the ML model 124 may avoid items associated with the client's competitors, such as branded apparel items.

To select digital content item(s) 122 for the event, the ML model 124 analyzes the event context data, item context data, and identified attribute(s), and searches the item database 120 for matching digital content items 122. For example, the ML model 124 searches the item database 120 for one or more digital content items 122 that are associated with the identified attribute(s), that have historical usage data associated with events similar to the detected event, or the like. When multiple digital content items 122 are identified, the ML model 124 may determine a relevance level, with respect to the identified event, for each digital content item 122. For instance, the ML model 124 may consider an appropriateness of an item's formality level for the event type, the item's suitability for the expected weather conditions at the event location, or its compatibility with the preferences of known attendees. Additionally, or alternatively, the ML model 124 may analyze the event context data as it relates to item context data (e.g., stored in the item database 120) associated with each digital content item 122, such as by generating a mapping between the event context data and the item context data or otherwise correlating event characteristics to item characteristics. The ML model 124 may also take into account the user's past behavior patterns, such as frequently worn items for similar event types, highly rated items from previous occasions, or the recency of an item's last use (e.g., to avoid repetitive recommendations and ensure variety in the user's choices). Additionally, the ML model 124 may utilize collaborative filtering or content-based filtering to identify items that are similar to those the user has favored in comparable situations.

Through this comprehensive analysis, the ML model 124 generates a relevance score for each digital content item 122, where more relevant items are assigned higher relevance scores. This process ensures that the recommendations are not only contextually relevant but also personalized to the user's preferences and past behaviors, enhancing the overall utility and accuracy of the suggestions provided by the context-aware selection module 116. The context-aware selection module 116 selects at least one digital content item 122 associated with a highest relevance score. The context-aware selection module 116 then presents the selected digital content item(s) 122 to the user in the notification 128 displayed via the user interface 126. The notification 128 may include or be an example of a pop-up alert, a banner, or an in-app message. In implementations, the notification 128 provides information about the detected event.

While the examples described herein generally relate to digital content items that correspond to apparel items, the described techniques can be applied to any type or quantity of items, and the examples herein should not be construed as limiting. As an example, the item database 120 may include digital content items 122 corresponding to gifts received by the user. The context-aware selection module 116 may analyze content from the device applications 114 to detect a gift and may collect and/or determine associated item context data. For instance, the event detector 118 can detect when the user sends a message thanking someone for a gift, and the ML model 124 can analyze the message to determine gift-related information, such as a type, occasion, a person who gave the gift, a date of receipt, a significance and/or sentimental value, and any associated photos or videos. The context-aware selection module 116 can store the information in the item database 120. In some examples, the ML model 124 can automatically determine the significance and/or sentimental value (e.g., based on a corresponding occasion and/or identity of the giver), while in other examples, the significance and/or sentimental value may be input by the user. The item database 120 may also include metadata such as a gift's monetary value, brand, color, size, or style preferences indicated by the user.

When the event detector 118 identifies an upcoming visit from someone who previously gave the user a gift, the context-aware selection module 116 may initiate the item selection process. The ML model 124 may analyze the event context, including the visitor's identity and relationship to the user, and compare it with the gift-related data stored in the item database 120. This analysis may consider factors such as the recency of the gift, its significance and/or sentimental value, and whether it has been used or displayed before. Based on this evaluation, the ML model 124 may select an appropriate (e.g., relevant) gift-related item. The context-aware selection module 116 may display the selection to the user via the notification 128. In this example, the context-aware selection module 116 can generate and display additional information, such as suggesting that the user display a particular gift item in a particular location or wear a gifted piece of clothing during the visit.

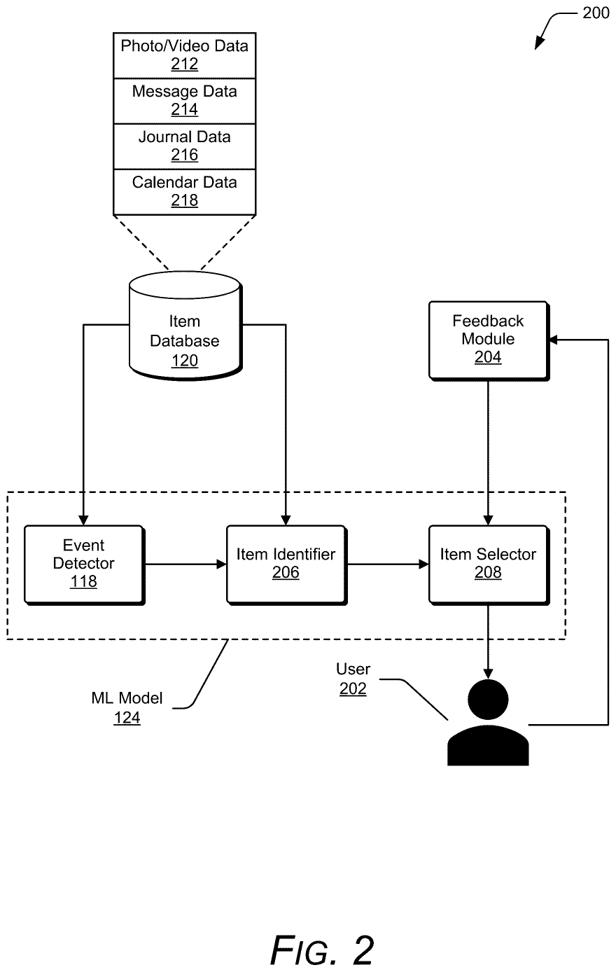

FIG. 2 illustrates an example 200 of context-aware selection of digital content items, as described herein. The example 200 may implement aspects of the example communication system 100. For instance, the example 200 can be implemented by a context-aware selection module 116 of a mobile device 102 as described with reference to FIG. 1. Additionally, the example 200 includes the item database 120 and the ML model 124 (e.g., as described with reference to FIG. 1), which are implemented to process digital content, detect events, infer context data, select appropriate digital content items, and present selections to a user 202. The user 202 may provide feedback about the selected digital content items via a feedback module 204. The ML model 124 implements or is implemented by the event detector 118 (e.g., as described with reference to FIG. 1), an item identifier 206, and an item selector 208.

The event detector 118 detects an event to be attended by the user 202 of the mobile device. In implementations, the event is detected based on user input indicating an event, such as via. Additionally, or alternatively, the event detector 118 implements or is implemented by the ML model 124 to continuously monitor (e.g., scan) content on the mobile device for indicators of upcoming events. For example, the event detector 118 may process content and data from device applications such as entries in a calendar application, text and images/videos from messaging applications, and the like, to identify event-related keywords, dates, and other relevant data that signify events. The event detector 118 may detect phrases like “meeting” or “party” in messages or recognize calendar entries with attributes suggesting an event.

In addition to detecting events, the ML model 124 may continuously or periodically scan (e.g., parse, analyze) digital content of the mobile device to identify digital content items and extract event data and item data. For example, the ML model 124 may utilize computer vision algorithms (e.g., image recognition, object detection) to detect digital content items in photos and videos of a social media application, such as clothing items, accessories, or decorative pieces, as well as optical character recognition (OCR) to extract text information like brand names or product descriptions. As another example, based on (e.g., subsequent to) detecting an event within a source, such as a calendar entry, the ML model 124 extracts relevant information such as event time, location, attendees, and purpose from the source. Additionally, the ML model 124 may identify and extract event-related information from other sources (e.g., scanning text messages, photos, email applications) to establish comprehensive event data.

The item database 120 stores extracted item data and event data, such as photo/video data 212, message data 214, journal data 216, and calendar data 218. In implementations, when an indicator of a digital content item and/or event is detected, the ML model 124 classifies and organizes the corresponding extracted data for storage in the item database 120. For instance, when a new photo containing apparel is detected, the ML model 124 can automatically add the apparel items to the database with appropriate attributes derived from the context in which they appear. As a specific example, the ML model 124 may detect, in an email, an indicator in the form of a purchase receipt and may analyze the email to identify a sweater purchased by the user 202, as well as any associated attributes (e.g., type, color, size). The ML model 124 automatically updates the item database 120 with a database entry for the sweater and populates the entry with the attributes.

The ML model 124 processes the scanned content and extracted data to determine (e.g., generate, derive, infer) event context data and item context data. The ML model 124 may be pre-trained to recognize patterns and contextual cues associated with events and items. For instance, the ML model 124 may associate event-related phrases like “wedding” with a high formality level (e.g., a suit), or “lunch” and a location of an office with a time duration of an hour. In some examples, the ML model 124 may also analyze historical user behavior patterns for similar events and items. The ML model 124 determines event context data for an event by analyzing collected event data, such as a location (e.g., a restaurant, an office, a concert venue), time information (e.g., evening, morning), attendees, and the like, and associating the event data with relevant contextual information, such as a formality level (e.g., casual, formal), a type (e.g., client meeting, wedding, lunch), attendee relationships (e.g., colleagues, friends, clients). As an example, the ML model 124 may associate an office location and an event time of 12:00 pm with contexts such as “lunch” and “business casual.”

To determine item context data for a digital content item, the ML model 124 analyzes item data such as style, type, etc. and associates the item data with relevant contextual information, such as a purpose, usage history, relationships with other items, associated individuals, relevant events, and the like. For example, the ML model 124 can process and analyze item data stored in the item database 120 and/or extracted from digital content to infer item context data. The ML model 124 may store the item context data in the item database 120, such as by populating a database entry associated with a digital content item with the item context data. Additionally, or alternatively, the ML model 124 may assign tags to one or more digital content items within the item database 120. As an example, the ML model 124 may tag a digital content item with calendar data extracted from a calendar application, such as event information.

Upon detection of an event by the event detector 118, the ML model 124 implements the item identifier 206 to identify relevant digital content items in the item database 120. The item identifier 206 generates appropriate item attributes for the event by analyzing the event context data. For example, for a formal business meeting, the item identifier 206 might generate attributes like “professional attire” and “recently unworn.” The item identifier 206 then searches and filters the item database 120 to find one or more digital content items matching these attributes. Additionally, or alternatively, the item identifier 206 can search the item database 120 for digital content items associated with a same event type or event attribute(s) (e.g., as extracted from the event data), such as digital content items tagged with similar events. For example, for an event identified as “wedding,” the item identifier 206 may search the item database 120 for digital content items tagged with “wedding.” For an event identified as “trip to the beach,” the item identifier 206 can search for items tagged with “swimming,” “sun protection,” and the like.

Using the digital content items retrieved by the item identifier 206, the ML model 124 implements or is implemented by the item selector 208 to choose a relevant digital content item. If the item identifier 206 retrieves more than one digital content item from the item database 120, the item selector 208 determines and assigns a respective relevance score for each of the digital content items based on a mapping (e.g., an association) between item context data associated with the digital content items and the event context data. In implementations, the item selector 208 generates the mapping based on factors such as a degree of attribute match, past performance of items in similar contexts, and user feedback. The item selector 208 assigns higher relevance scores to digital content items that are more closely aligned with the detected event. The item selector 208 selects a digital content item with the highest relevance score to display to the user 202, e.g., via a user interface of the mobile device. In some examples, the item selector 208 may select multiple digital content items for display, such as a subset of relevant digital content items (e.g., an apparel item and one or more accessories).

In implementations, the user 202 can provide feedback about the selected digital content item through the feedback module 204, which may include or be an example of the user interface 126 as described with reference to FIG. 1. This feedback can include explicit ratings (e.g., thumbs up/down), acceptance or rejection of recommendations, or implicit feedback based on user actions (e.g., whether they used the recommended item for the event). The feedback may be utilized to update the ML model 124, refining selection criteria and improving future recommendations. For instance, if the user 202 consistently rejects formal attire suggestions for some events, the ML model 124 learns to adjust its formality assessment for similar future events. Additionally, or alternatively, the ML model 124 can update the item database 120 according to the feedback, adjusting item attributes or relevance scores based on user responses. Through this continuous cycle of scanning, learning, recommending, and incorporating feedback, the example 200 provides an adaptive and personalized system for managing and recommending digital content items in the context of user events and activities.

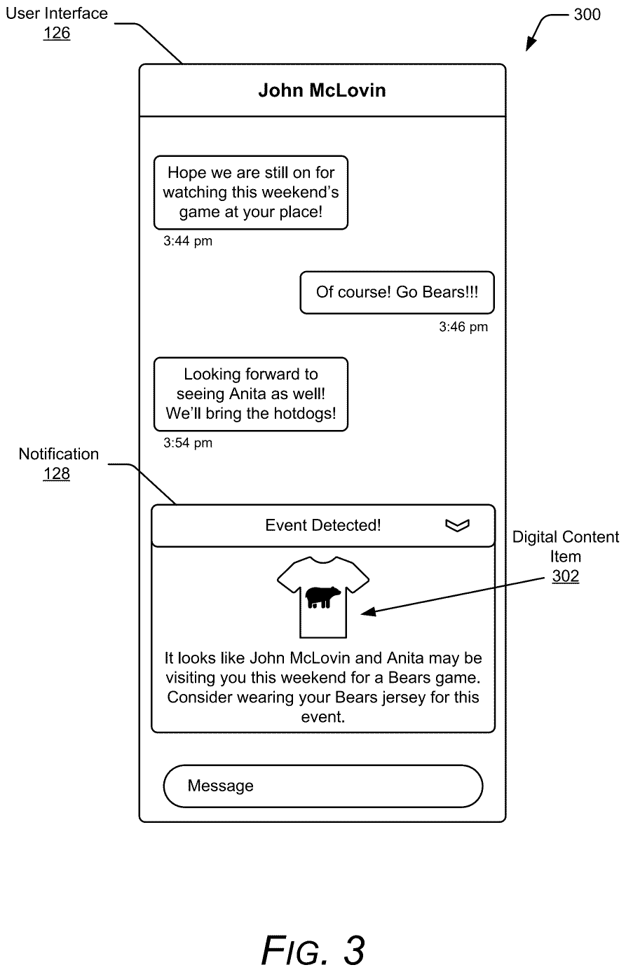

FIG. 3 illustrates an example GUI 300 for providing digital content recommendations in accordance with one or more implementations as described herein. The GUI 300 may implement or be implemented by aspects of the communication system 100. For example, the GUI 300 includes a user interface 126 and a notification 128 as described with reference to FIG. 1. The user interface 126 and the notification 128 may be implemented by the context-aware selection module 116 to display one or more selected digital content items 122 to a user as described herein.

The user interface 126 may include controls for selection or other interaction by the user. As illustrated, the user interface 126 displays a messaging application of the mobile device. The context-aware selection module 116 may implement the event detector 118 to scan the content of the messaging application and detect an event. For example, using natural language processing techniques, the context-aware selection module 116 identifies indicators of potential events, such as mentions of dates and times, locations, or phrases like “watching this weekend's game.” When such indicators are detected, the context-aware selection module 116 implements the event detector 118 to extract relevant event data from the messages, such as a type of event (e.g., watching a sports game) and potential attendees (e.g., John and Anita).

The ML model 124 then processes this extracted event data to derive more comprehensive event context data. This may include determining the formality level of the event (casual), the relationship between attendees (friends), and a likely location based on historical patterns or explicit mentions. For example, the ML model 124 may infer that the location of the event is at the user's home based on the phrase “at your place” in a received message. Simultaneously, the ML model 124 analyzes the item database 120 to generate item context data for potential recommendations, considering factors such as item type, usage history, and associations with similar past events.

To select an appropriate digital content item, the ML model 124 performs a multi-step analysis. The ML model 124 identifies relevant item attributes based on the event context, such as casual attire for a sports viewing event or tags corresponding to similar event types. The ML model 124 then filters digital content items in the item database 120 to retrieve a set of one or more digital content items 122 matching these attributes. The ML model 124 may calculate a relevance score for each digital content item 122 in the by mapping the item context data to the event context data, considering factors like previous usage at similar events, color preferences, and comfort ratings. The ML model 124 selects a digital content item 302 with a highest relevance score from among the set of digital content items 122.

The context-aware selection module 116 generates a notification 128 indicating the digital content item 302, such as text describing the digital content item 302. In implementations, the notification 128 includes a visual representation of the digital content item 302, such as an image or an icon. The notification 128 may also display relevant event data collected or inferred from the conversation, such as the event type (game watching, friends visiting) and time (this weekend). The user interface 126 displays the notification 128 to the user as an integrated part of the messaging conversation. This on-demand presentation ensures that the recommendation is timely and contextually relevant, appearing shortly after the event is discussed in the conversation. Alternative display methods can include pop-up notifications, banner alerts, or in-app notifications. This presentation method allows the context-aware selection module 116 to provide recommendations that are seamlessly integrated into the user's ongoing conversations and activities.

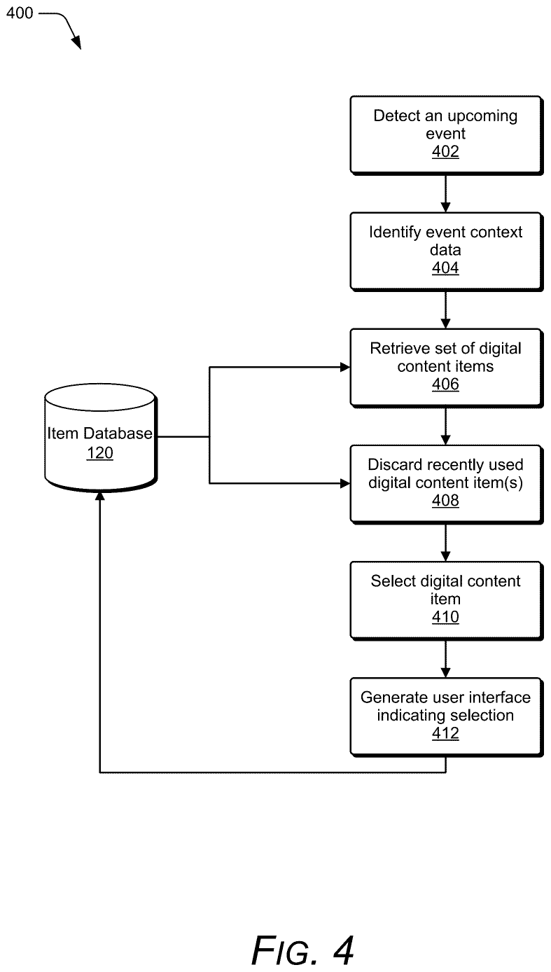

Example methods 400, 500, and 600 are described with reference to respective FIGS. 4, 5, and 6 in accordance with one or more implementations of context-aware selection of digital content items, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates an example method 400 for selecting digital content items using context data in accordance with one or more implementations as described herein. The method 400 may implement aspects of the communication system 100. For example, the method 400 can be implemented by the context-aware selection module 116 of the mobile device 102 to facilitate selection of digital content items 122 from an item database 120 as described with reference to FIG. 1. The order in which the method is described is not intended to be construed as a limitation, and any number or combination of the described operations can be performed in any order.

At 402, an event to be attended by a user of the mobile device 102 is detected. For example, the context-aware selection module 116 may detect indicators of an event from a calendar application, a messaging application, or other device applications on the mobile device 102. In implementations, the context-aware selection module 116 scans content of one or more device applications on the mobile device 102 and identifies (e.g., using an ML model, such as the ML model 124) one or more indicators of the event within the scanned content. In some implementations, the mobile device 102 receives a user input indicating the event. The context-aware selection module 116 may extract event data associated with the event.

At 404, event context data associated with the event is identified. For instance, the context-aware selection module 116 may utilize the ML model 124 to determine the event context data based on the event data. The ML model 124 can classify the event data by associating it with event contexts. The event context data may include at least one of an attendee, an event type, a location, a formality level, an event start time, and an event duration.

At 406, a set of digital content items is retrieved from the item database 120. For example, the context-aware selection module 116 may utilize the ML model 124 to identify a set of digital content items associated with item attributes relevant to the detected event. In implementations, the ML model 124 generates the item attributes based on the event context data.

At 408, one or more recently used digital content items may be discarded from the set of digital content items. As an example, the item database 120 may store usage history for each digital content item, which the ML model 124 may consider when selecting a digital content item for recommendation to a user. By deprioritizing or discarding recently used digital content items, the context-aware selection module 116 ensures variety in recommendations and avoids repetitive suggestions. Additionally, this method accounts for practical considerations such as laundry cycles or item availability, as well as social norms that discourage wearing the same outfit to consecutive events with overlapping attendees.

At 410, a digital content item is selected from the set of digital content items. For instance, the ML model 124 may select a relevant digital content item, e.g., based on a relevance level, a degree of attribute match, or the like.

At 412, a user interface indicating the selected digital content item is selected. For example, the context-aware selection module 116 may generate the user interface 126 that displays an image of the selected digital content item. In some implementations, the user interface further indicates at least a portion of the event data, such as a date and time, a location, and so forth.

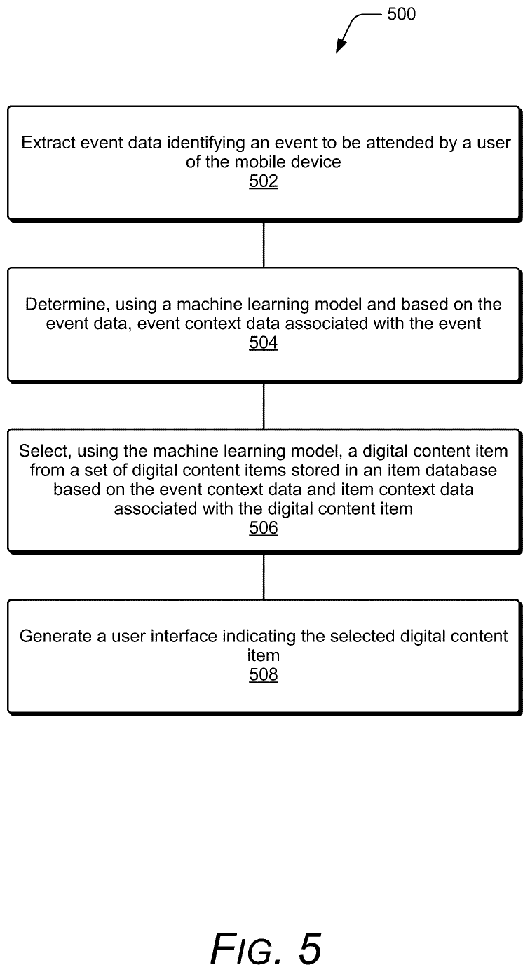

FIG. 5 illustrates example method(s) 500 for context-aware selection of digital content items. The order in which the method is described is not intended to be construed as a limitation, and any number or combination of the described operations can be performed in any order.

At 502, event data identifying an event to be attended by a user of a mobile device is extracted. For example, the context-aware selection module 116 extracts event data from various sources on the mobile device 102, such as calendar entries, messages, or other device applications 114. In one implementation, the context-aware selection module 116 receives a user input indicating the event. Alternatively or in addition, the context-aware selection module 116 scans content of one or more device applications on the mobile device and identifies, using the ML model 124, one or more indicators of the event within the scanned content.

At 504, event context data associated with the event is determined using an ML model based on the event data. For instance, the context-aware selection module 116 implements the ML model 124 to analyze the extracted event data and determine associated context information. The event context data may include attributes such as an attendee, an event type, a location, a formality level, an event start time, and an event duration. In some implementations, the ML model 124 classifies the event data to associate it with specific event contexts.

At 506, a digital content item is selected from a set of digital content items stored in an item database using the ML model. The selection is based on the event context data and item context data associated with the digital content item. For example, the context-aware selection module 116 maintains an item database 120 of digital content items and associated item context data, where the item context data includes one or more item attributes such as an item type, a formality level, an event type, an association with a person or entity, or a usage history.

In one or more implementations, to select the digital content item, the ML model 124 analyzes the event context data to determine at least one item attribute relevant to the event. The context-aware selection module 116 searches and filters the item database 120 to obtain the set of digital content items based on each digital content item of the set being associated with the at least one item attribute. The ML model 124 determines a respective relevance level for each digital content item of the set based on a mapping between the item context data and the event context data, and selects the digital content item based on the respective relevance levels.

In some examples, the context-aware selection module 116 scans content of one or more device applications on the mobile device and detects, using the ML model 124, one or more indicators of digital content items within the scanned content. The context-aware selection module 116 may automatically generate the item database 120 by classifying the digital content items using the ML model 124 trained to associate the one or more indicators with the digital content items. The context-aware selection module 116 extracts, using the ML model 124, item context data associated with the digital content items from within the scanned content, generates a respective database entry for each digital content item, and populates the respective database entry with one or more item attributes associated with each digital content item based on the item context data.

The context-aware selection module 116 may analyze, using the ML model 124, the item context data associated with each digital content item and generate the one or more item attributes based on the analysis. In some cases, the context-aware selection module 116 automatically updates the item database 120 in response to receiving user input indicating a digital content item and one or more item attributes.

At 508, a user interface indicating the selected digital content item is generated. For instance, the context-aware selection module 116 generates a user interface 126 that displays information about the selected digital content item, which may include an image or description of the item. In some implementations, the user interface 126 further indicates at least a portion of the event data.

The context-aware selection module 116 may also process calendar data associated with a calendar application on the mobile device. In some implementations, the context-aware selection module 116 tags, using the ML model 124, one or more digital content items in the item database 120 with the calendar data.

After presenting the selection, the context-aware selection module 116 may receive user feedback on the selected digital content item and update the ML model 124 or the item database 120 based on the user feedback. This feedback loop allows the system to continuously improve its recommendations based on user preferences and behaviors.

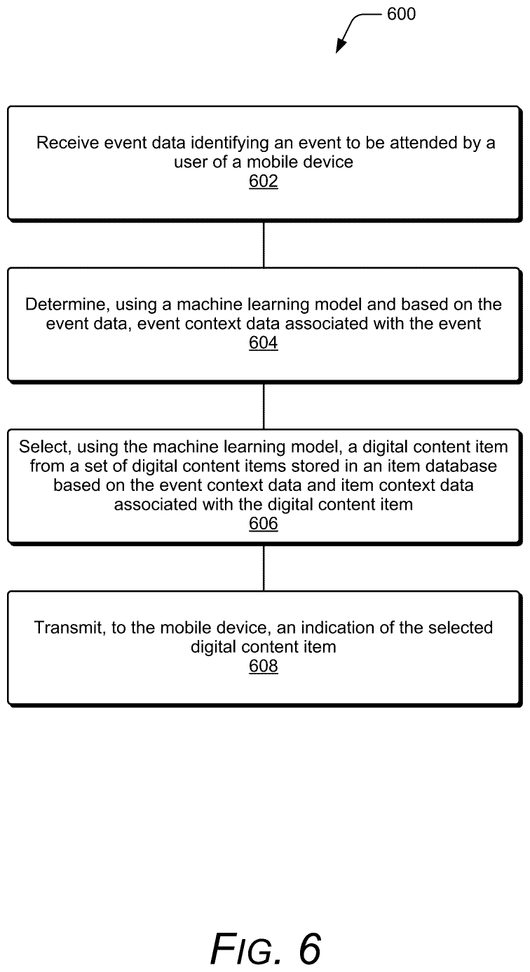

FIG. 6 illustrates an example method 600 for selecting digital content items using contextual data. The order in which the method is described is not intended to be construed as a limitation, and any number or combination of the described method operations can be performed in any order to perform a method, or an alternate method.

At 602, event data identifying an event to be attended by a user of a mobile device is received. For example, the context-aware selection manager 134 of the server device 104 receives event data from the mobile device 102 via the network 106. The event data may be extracted by the mobile device 102 from various sources such as calendar entries, messages, or other device applications.

At 604, event context data associated with the event is determined using an ML model based on the event data. For instance, the context-aware selection manager 134 implements the ML model 140 to analyze the received event data and determine associated context information. The ML model 140 may classify the event data to associate it with event context data. In implementations, the event context data includes at least one of an attendee, an event type, a location, a formality level, an event start time, and an event duration.

At 606, a digital content item is selected from a set of digital content items stored in an item database using the ML model. The selection is based on the event context data and item context data associated with the digital content item. For example, the server device 104 maintains an item database 136 of digital content items and associated item context data, where the item context data includes one or more item attributes.

To select the digital content item, the ML model 140 analyzes the event context data to determine at least one item attribute relevant to the event. The context-aware selection manager 134 then searches and filters the item database 136 to obtain the set of digital content items based on each digital content item of the set being associated with the at least one item attribute. The ML model 140 determines a respective relevance level for each digital content item of the set based on a mapping between the item context data and the event context data, and selects the digital content item based on the respective relevance levels.

At 608, an indication of the selected digital content item is transmitted to the mobile device. For instance, the server device 104 sends information about the selected digital content item to the mobile device 102 via the network 106. The mobile device 102 may then generate a user interface to display the selected digital content item to the user.

FIG. 7 illustrates various components of an example device 700, which can implement aspects of the techniques and features for context-aware selection of digital content items, as described herein. The example device 700 may be implemented as any of the devices described with reference to the previous FIGS. 1-6, such as any type of a wireless device, mobile device, mobile phone, flip phone, client device, companion device, display device, tablet, computing, communication, entertainment, gaming, media playback, and/or any other type of computing and/or electronic device. For example, the mobile device 102 described with reference to FIGS. 1-6 may be implemented as the example device 700.

The example device 700 can include various, different communication devices 702 that enable wired and/or wireless communication of device data 704 with other devices. The device data 704 can include any of the various devices, data, and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input/output (I/O) interfaces 706, such as data network interfaces that provide connection and/or communication links between the devices, data networks, and other devices. The data I/O interfaces 706 may be used to couple the device to any type of components, peripherals, and/or accessory devices, such as a computer input device that may be integrated with the example device 700. The I/O interfaces 706 may also include data input ports via which any type of data, information, media content, communications, messages, and/or inputs may be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 712 include volatile memory and non-volatile memory, fixed and removable media devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage media device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 may be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In this example, the device 700 includes a context-aware selection module 718 that implements various aspects of the described features and techniques described herein. The context-aware selection module 718 may be implemented with hardware components and/or in software as one of the device applications 714, such as when the example device 700 is implemented as the mobile device 102 described with reference to FIGS. 1-6. An example of the context-aware selection module 718 is the context-aware selection module 116 implemented by the mobile device 102, such as a software application and/or as hardware components in the mobile device. In implementations, the context-aware selection module 718 may include independent processing, memory, and logic components as a computing and/or electronic device integrated with the example device 700.

The example device 700 can also include a microphone 720 (e.g., to capture an audio recording of a user) and/or camera devices 722 (e.g., to capture video images of the user during a call), as well as device sensors 724, such as may be implemented as components of an inertial measurement unit (IMU). The device sensors 724 may be implemented with various sensors, such as a gyroscope, an accelerometer, and/or other types of motion sensors to sense motion of the device. The device sensors 724 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources 726, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 700 can also include an audio and/or video processing system 728 that generates audio data for an audio system 730 and/or generates display data for a display system 732. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 700. Alternatively, the audio system and/or the display system are external, peripheral components to the example device.

Although implementations for context-aware selection of digital content items have been described in language specific to features and/or methods, the appended claims are not necessarily limited to the specific features or methods described. Rather, the specific features and methods are disclosed as example implementations for context-aware selection of digital content items, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, comprising at least one memory; and at least one processor coupled with the at least one memory and operable to cause the mobile device to extract event data identifying an event to be attended by a user of the mobile device; determine, using a machine learning model and based on the event data, event context data associated with the event; select, using the machine learning model, a digital content item from a set of digital content items stored in an item database based on the event context data and item context data associated with the digital content item; and generate a user interface indicating the selected digital content item.

A mobile device wherein, to extract the event data, the at least one processor is further operable to cause the mobile device to receive a user input indicating the event.

A mobile device wherein, to extract the event data, the at least one processor is further operable to cause the mobile device to: scan content of one or more device applications on the mobile device; and identify, using the machine learning model, one or more indicators of the event within the scanned content.

A mobile device wherein, to determine the event context data associated with the event, the at least one processor is further operable to cause the mobile device to: classify the event data using the machine learning model trained to associate the event data with event contexts, the event context data including at least one of an attendee, an event type, a location, a formality level, an event start time, and an event duration.

A mobile device wherein the user interface further indicates at least a portion of the event data.

A mobile device wherein, to extract the event data, the at least one processor is further operable to cause the mobile device to process calendar data associated with a calendar application on the mobile device.

A mobile device wherein the at least one processor is further operable to cause the mobile device to tag, using the machine learning model, one or more digital content items in the item database with the calendar data.

A mobile device wherein the at least one processor is further operable to cause the mobile device to maintain the item database of digital content items and item context data, wherein the item context data includes one or more item attributes.

A mobile device wherein the one or more item attributes include at least one of an item type, a formality level, an event type, an association with a person or entity, or a usage history.

A mobile device wherein, to select the digital content item, the at least one processor is further operable to cause the mobile device to analyze, using the machine learning model, the event context data to determine at least one item attribute relevant to the event; search and filter the item database to obtain the set of digital content items based on each digital content item of the set of digital content items being associated with the at least one item attribute; and determine, using the machine learning model, a respective relevance level for each digital content item of the set of digital content items based on a mapping between the item context data and the event context data, wherein the digital content item is selected based on the respective relevance levels.

A mobile device, wherein the at least one processor is further operable to cause the mobile device to scan content of one or more device applications on the mobile device; and detect, using the machine learning model, one or more indicators of digital content items within the scanned content.

A mobile device wherein the at least one processor is further operable to cause the mobile device to automatically generate the item database by classifying the digital content items using the machine learning model trained to associate the one or more indicators with the digital content items; extracting, using the machine learning model, item context data associated with the digital content items from within the scanned content; generating a respective database entry for each digital content item of the digital content items; and populating the respective database entry with one or more item attributes associated with each digital content item based on the item context data.

A mobile device wherein the at least one processor is further operable to cause the mobile device to analyze, using the machine learning model, the item context data associated with each digital content item; and generate the one or more item attributes based on the analysis.

A mobile device wherein the at least one processor is further operable to cause the mobile device to automatically update the item database in response to receiving user input indicating a digital content item and one or more item attributes.

A mobile device wherein the at least one processor is further operable to cause the mobile device to receive user feedback on the selected digital content item; and update the machine learning model or the item database based on the user feedback.

Alternatively, or in addition to the above-described mobile device, any one or combination of:

A method, comprising extracting event data identifying an event to be attended by a user of the mobile device; determining, using a machine learning model and based on the event data, event context data associated with the event; selecting, using the machine learning model, a digital content item from a set of digital content items stored in an item database based on the event context data and item context data associated with the digital content item; and generating a user interface displaying the selected digital content item.

Alternatively, or in addition to the above-described method, any one or combination of:

A system, comprising at least one memory; and at least one processor coupled with the at least one memory and operable to cause the system to receive event data identifying an event to be attended by a user of a mobile device; determine, using a machine learning model and based on the event data, event context data associated with the event; select, using the machine learning model, a digital content item from a set of digital content items stored in an item database based on the event context data and item context data associated with the digital content item; and transmit, to the mobile device, an indication of the selected digital content item.

A system, wherein, to determine the event context data associated with the event, the at least one processor is further operable to cause the system to classify the event data using the machine learning model trained to associate the event data with contexts, the event context data including at least one of an attendee, an event type, a location, a formality level, an event start time, and an event duration.

A system, wherein the at least one processor is further operable to cause the system to maintain the item database of digital content items and item context data, wherein the item context data includes one or more item attributes.

A system, wherein, to select the digital content item, the at least one processor is further operable to cause the system to analyze, using the machine learning model, the event context data to determine at least one item attribute relevant to the event; search and filter the item database to obtain the set of digital content items based on each digital content item of the set of digital content items being associated with the at least one item attribute; and determine, using the machine learning model, a respective relevance level for each digital content item of the set of digital content items based on a mapping between the item context data and the event context data, wherein the digital content item is selected based on the respective relevance levels.

What is claimed is:

1. A mobile device, comprising:
at least one memory; and
at least one processor coupled with the at least one memory and operable to cause the mobile device to:
extract event data identifying an event to be attended by a user of the mobile device;
determine, using a machine learning model and based on the event data, event context data associated with the event;
select, using the machine learning model, a digital content item from a set of digital content items stored in an item database based on the event context data and item context data associated with the digital content item; and
generate a user interface indicating the selected digital content item.

2. The mobile device of claim 1, wherein, to extract the event data, the at least one processor is further operable to cause the mobile device to receive a user input indicating the event.

3. The mobile device of claim 1, wherein, to extract the event data, the at least one processor is further operable to cause the mobile device to:
scan content of one or more device applications on the mobile device; and
identify, using the machine learning model, one or more indicators of the event within the scanned content.

4. The mobile device of claim 3, wherein, to determine the event context data associated with the event, the at least one processor is further operable to cause the mobile device to:
classify the event data using the machine learning model trained to associate the event data with event contexts, the event context data including at least one of an attendee, an event type, a location, a formality level, an event start time, and an event duration.

5. The mobile device of claim 3, wherein the user interface further indicates at least a portion of the event data.

6. The mobile device of claim 1, wherein, to extract the event data, the at least one processor is further operable to cause the mobile device to process calendar data associated with a calendar application on the mobile device.

7. The mobile device of claim 6, wherein the at least one processor is further operable to cause the mobile device to tag, using the machine learning model, one or more digital content items in the item database with the calendar data.

8. The mobile device of claim 1, wherein the at least one processor is further operable to cause the mobile device to maintain the item database of digital content items and item context data, wherein the item context data includes one or more item attributes.

9. The mobile device of claim 8, wherein the one or more item attributes include at least one of an item type, a formality level, an event type, an association with a person or entity, or a usage history.

10. The mobile device of claim 1, wherein, to select the digital content item, the at least one processor is further operable to cause the mobile device to:
analyze, using the machine learning model, the event context data to determine at least one item attribute relevant to the event;
search and filter the item database to obtain the set of digital content items based on each digital content item of the set of digital content items being associated with the at least one item attribute; and
determine, using the machine learning model, a respective relevance level for each digital content item of the set of digital content items based on a mapping between the item context data and the event context data, wherein the digital content item is selected based on the respective relevance levels.

11. The mobile device of claim 1, wherein the at least one processor is further operable to cause the mobile device to:
scan content of one or more device applications on the mobile device; and
detect, using the machine learning model, one or more indicators of digital content items within the scanned content.

12. The mobile device of claim 11, wherein the at least one processor is further operable to cause the mobile device to automatically generate the item database by:
classifying the digital content items using the machine learning model trained to associate the one or more indicators with the digital content items;
extracting, using the machine learning model, item context data associated with the digital content items from within the scanned content;
generating a respective database entry for each digital content item of the digital content items; and
populating the respective database entry with one or more item attributes associated with each digital content item based on the item context data.

13. The mobile device of claim 12, wherein the at least one processor is further operable to cause the mobile device to:
analyze, using the machine learning model, the item context data associated with each digital content item; and
generate the one or more item attributes based on the analyzing.

14. The mobile device of claim 1, wherein the at least one processor is further operable to cause the mobile device to automatically update the item database in response to receiving user input indicating a digital content item and one or more item attributes.

15. The mobile device of claim 1, wherein the at least one processor is further operable to cause the mobile device to:
receive user feedback on the selected digital content item; and
update the machine learning model or the item database based on the user feedback.

16. A system, comprising:
at least one memory; and
at least one processor coupled with the at least one memory and operable to cause the system to:
receive event data identifying an event to be attended by a user of a mobile device;
determine, using a machine learning model and based on the event data, event context data associated with the event;
select, using the machine learning model, a digital content item from a set of digital content items stored in an item database based on the event context data and item context data associated with the digital content item; and
transmit, to the mobile device, an indication of the selected digital content item.

17. The system of claim 16, wherein, to determine the event context data associated with the event, the at least one processor is further operable to cause the system to:
classify the event data using the machine learning model trained to associate the event data with contexts, the event context data including at least one of an attendee, an event type, a location, a formality level, an event start time, and an event duration.

18. The system of claim 16, wherein the at least one processor is further operable to cause the system to maintain the item database of digital content items and item context data, wherein the item context data includes one or more item attributes.

19. The system of claim 16, wherein, to select the digital content item, the at least one processor is further operable to cause the system to:
analyze, using the machine learning model, the event context data to determine at least one item attribute relevant to the event;
search and filter the item database to obtain the set of digital content items based on each digital content item of the set of digital content items being associated with the at least one item attribute; and
determine, using the machine learning model, a respective relevance level for each digital content item of the set of digital content items based on a mapping between the item context data and the event context data, wherein the digital content item is selected based on the respective relevance levels.

20. A method performed by a mobile device, comprising:
extracting event data identifying an event to be attended by a user of the mobile device;
determining, using a machine learning model and based on the event data, event context data associated with the event;
selecting, using the machine learning model, a digital content item from a set of digital content items stored in an item database based on the event context data and item context data associated with the digital content item; and
generating a user interface displaying the selected digital content item.
